(19) United States
(12) Patent Application Publication
(10) Pub. No.: US 2010/0333061 A1
(43) Pub. Date: Dec. 30, 2010

(54) EXPLICIT STATE MODEL CHECKING OF SL/SF MODELS USING THE AUTO-GENERATED CODE

(75) Inventors: Swarup K. Mohalik, Bangalore (IN); Suresh Jeyaraman, Bangalore (IN); Sathyaraja H. Nandugudi, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/491,906

(22) Filed: Jun. 25, 2009

(51) Int. Cl. G06G 7/66; G06F 9/455; G05B 19/042

(52) U.S. Cl. 717/104; 717/135; 717/127; 717/128; 700/86

(57) ABSTRACT

A system and a method for validating a model for a control system as per a set of specifications. The method includes obtaining a model code corresponding to the model, where the model-code is generated by a modeling tool. Further, a test-code capable of monitoring one or more model parameters that need to be validated is generated using a testing tool. The model-code and the test-code are combined to obtain an integrated-code. The integrated code is executed in the testing tool that compares the obtained output values with the expected output values as provided in the specifications. Further, the model is identified as valid or invalid based on the comparison based on the results of the comparison.

### BACKGROUND OF THE INVENTION

1. Field of the Invention

This invention relates generally to a method for validating a model for one or many control systems deployable on a hardware architecture with one or more electronic controllers and, more particularly, to a method for verifying that a model is error free and valid for all modes of operation of a system.

2. Description of the Related Art

In any industry, especially in the automobile industry, each time a control system is designed to be used in a vehicle, or any other operative system, it is simulated using a model. The model is validated before a controller of the system is embedded into an operative system. Validation confirms the conformity of the model to all of the specifications of the control system and modes of operation of the operative system. Specifications primarily define the expected output characteristics of the control system corresponding to various inputs. Validation further involves ensuring that the model is completely error free. A large amount of funds and time may be required to develop the control system itself, and thus, the validation process of the model for the control system, prior to development, is indispensable.

One existing system used for validating a model or checking its compatibility with a system is based on simulation. The system involves input of various test sequences as per the specifications of the model and a comparison of the resulting output characteristics. However, to validate the model for all specifications of the control system and modes of operation of a system, there would be a need to design an infinite number of input test sequences and define the expected outputs for them. The inability to design unlimited test sequences to cover all possible scenarios clearly indicates that this validation technique is not exhaustive.

### SUMMARY OF THE INVENTION

In accordance with the teachings of the present invention a system and a method for validating a model for a control system as per a set of specifications are disclosed. The method includes obtaining a model-code corresponding to the model, where the model-code is generated by a modeling tool. Further, a test-code capable of monitoring one or more model-parameters that need to be validated is generated using a testing tool. The model-code and the test-code are combined to obtain an integrated-code. The integrated-code is executed in the testing tool that compares the obtained output values with the expected output values as provided in the specifications. Further, the model is identified as valid or invalid based on the comparison based on the results of the comparison.

Additional features of the present invention will become apparent from the following description and appended claims, taken in conjunction with the accompanying drawings.

### BRIEF DESCRIPTION OF THE DRAWINGS

FIG. 1 illustrates a method for validating an exemplary Simulink/Stateflow (SL/SF) model using auto-generated code, in accordance with an embodiment of the present invention;

FIG. 2 is an illustration of a method for back-tracing an error source based on a counter-example provided by a model checker; and

FIG. 3 is a block diagram illustrating a system for explicit model checking of SL/SF models using auto-generated code, in accordance with an embodiment of the present invention.

### DETAILED DESCRIPTION OF THE EMBODIMENTS

The following discussion of the embodiments of the invention directed to a system and method for validating a model for a control system is merely exemplary in nature, and is in no way intended to limit the invention or its applications or uses.

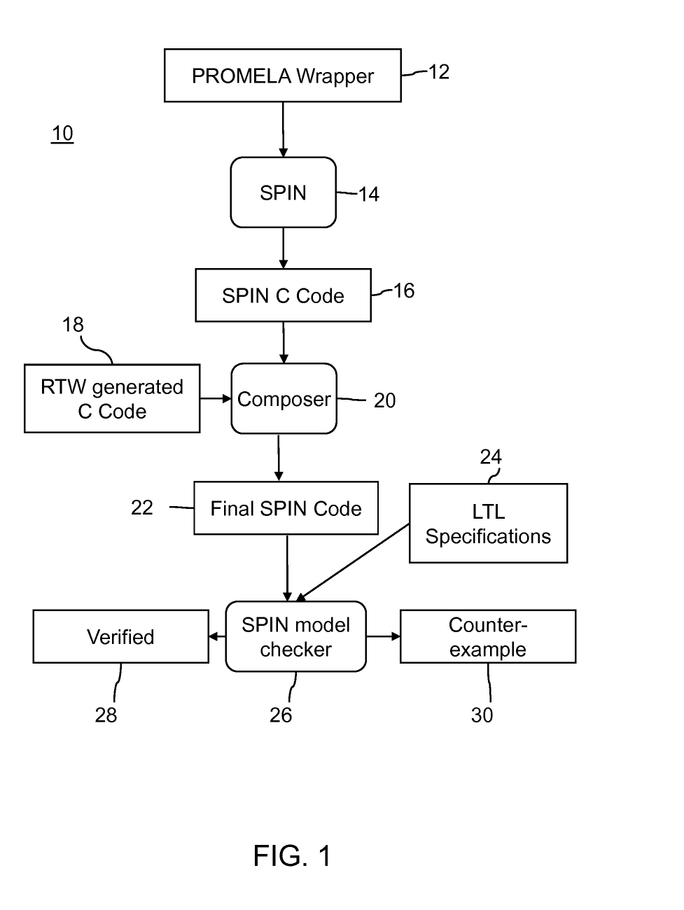

FIG. 1 illustrates a method 10 for validating an exemplary Simulink/Stateflow (SL/SF) model using auto-generated code, in accordance with an embodiment of the present invention. The SL/SF model is used for simulating a control system for automotive systems. This model needs to be validated before it is used in an application. Validation requires the comparison of the actual output values of the model-parameters, obtained by using a model-checker, with the expected output values of the model-parameters as defined in the specifications to verify the model.

A model-code specific to a model is written in a simulator. In one embodiment, the model is written in SL/SF environment. SL/SF codes are a part of a MATLAB application package, and the simulation semantics of the SL/SF code is defined by the SL/SF environment. In order to adapt this model to a validation process, the model is converted into a model-code by a modeling tool. In this embodiment, a conversion at box 18 of an SL/SF model to a model-code can be done by a modeling tool known as Real-Time Workshop (RTW) code generator. In one non-limiting embodiment, the generated code can be in C language.

Further, a test-code is generated from a wrapper 12 by a testing tool. The wrapper 12 has information about all of the functions that need to be called during the process of model validation and the variables that need to be monitored during model validation. The test-code generated is capable of monitoring one or more model-parameters that need to be validated. The functions in the wrapper 12 can be called during the execution of the process of validating the model. In this non-limiting embodiment, the test-code in the present illustration is a C language version of the wrapper 12 written in Process Meta Language (PROMELA). Further, the conversion at box 16 of the PROMELA wrapper to its C equivalent is done by using a testing tool called SPIN at box 14.

The model-code and test-code that are now in a common language, C in this embodiment, are combined to obtain an integrated-code. This integration is achieved using a composer at box 20. In one embodiment, the integrated-code can be the final SPIN code at box 22. The integrated-code is executed in a testing tool. In this embodiment, the testing tool is a model checker SPIN at box 26. Further, the final SPIN code and Linear Temporal Logic (LTL) values at box 24 are taken as inputs in the SPIN model-checker, which is used to validate the model. LTL is a temporal modal logic, where the modalities refer to time. LTL can be used to encode formula about the future of paths, for example, whether a condition will eventually be true, or if a condition will be true until another condition is true and the like.

In the present invention, the execution of the integrated-code in the testing tool results in the generation of a set of actual output values of a set of model-parameters. Further, a co-relation between the actual output values and the expected output values is identified. In one embodiment, the co-relation may be a comparison of the actual and expected output values. If the actual and expected output values are equal, then the model is identified as valid at box 28. In case the actual and expected values are found be different a counter-example at box 30 is generated, which is then used to back-trace the source of error that led to a difference in the two output values. To ensure an exhaustive validation process, which does not require infinite inputs to cover all specifications of the electronic controller, a model-checker is used as a testing tool, such as SPIN. The model-checker uses mechanisms, such as folding on recognition of a repeated pattern, so that the model does not get caught in an infinite loop and at the same time checks the conformity of the model with all the specifications of the control system. This is done when an input generates an output pattern that has been encountered in an earlier run of the model. The SPIN model-checker identifies the pattern and terminates the execution of the code to prevent an infinite loop.

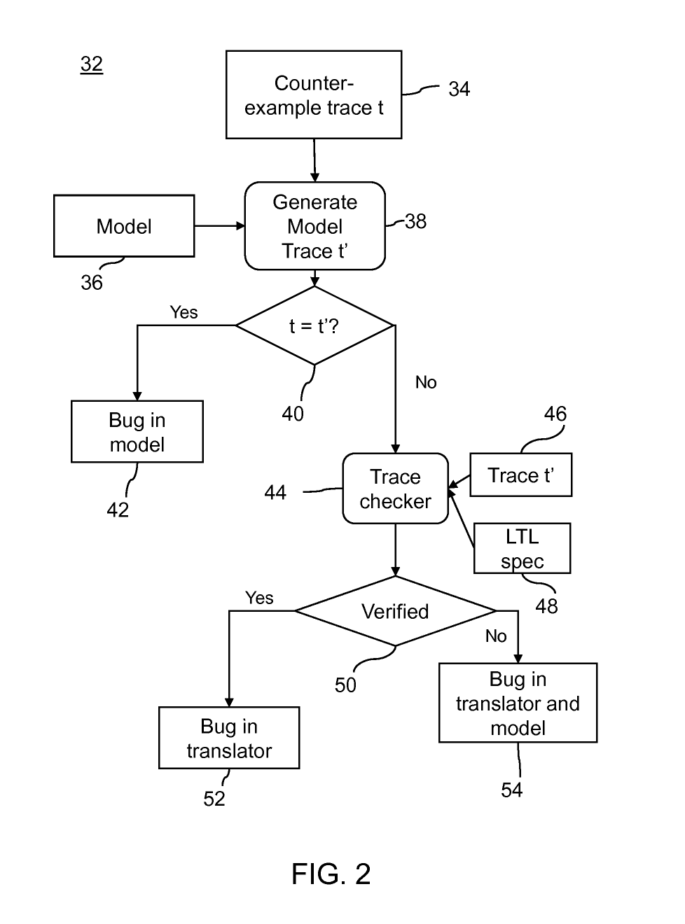

FIG. 2 is an illustration of a method 32 for back-tracing an error source based on a counter-example provided by a model-checker. In case the actual output values of model-parameters, for any set of input values, do not match the expected output values the verification is said to have failed. In this case, the SPIN model-checker generates a counter-example trace t, which, for example, can be the output value of a model-parameter generated by the integrated-code and corresponding to an input value at which the verification has failed. The counter-example trace t is generated at box 34. The same input value is used to verify the model and the corresponding output value is termed as a model trace t′. The model trace t′ at box 36 is generated from the model at box 38. The two traces t and t′ are compared at diamond 40.

If the values of the two traces t and t′ are found to be equal it becomes apparent that there is a bug in the model, as illustrated at box 42. If the values obtained are found to be different, it can be concluded that a semantic difference has been generated by the model-code generator. In such a case, the model trace t′ at box 46 is checked by a trace checker at box 44 using the LTL specifications at box 48. This is done to verify whether a bug lies only in the model-code generator or it lies in both the model-code generator and the model. This verification is done at diamond 50. In case the model trace t′ satisfies the model according to the specifications, it becomes evident that the model is correct, and the bug lies only in the model-code generator, as shown at box 52. On the other hand, if the model trace t′ is different from the counter-example trace t, and yet does not satisfy the model according to the specifications, it can be concluded that there is a bug in both the model and the model-code generator as shown at box 54.

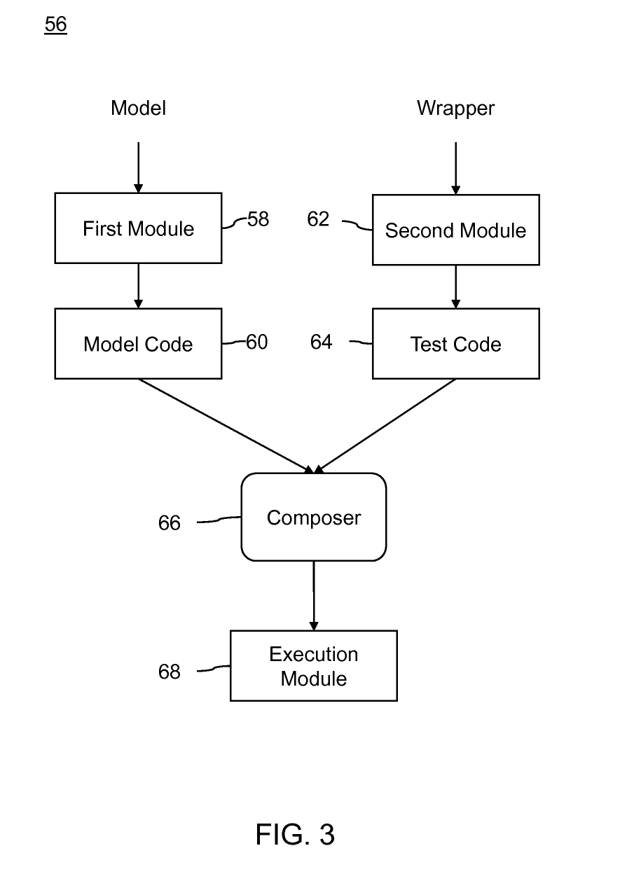

FIG. 3 is a block diagram of a system 56 for explicit model checking of SL/SF models using auto-generated code, in accordance with an embodiment of the present invention. The system 56 includes a first module 58 that is coupled with a modeling tool that converts the validation model into a model-code 60. The first module 58 retrieves the model-code 60 from the modeling tool. In one non-limiting embodiment, the modeling tool can be an RTW generator. There is a second module 62 coupled to a testing tool that receives a wrapper as input. The wrapper has information about all of the functions that need to be called during the process of model verification and the variables that need to be monitored during model validation. The second module retrieves a test-code 64 form the testing tool. The test-code 64 is capable of monitoring one or more model parameters that need to be validated. In one non-limiting embodiment, the wrapper can be written in PROMELA. In one non-limiting embodiment, the testing tool can be SPIN. The model-code 60 and the test-code 64 are both converted to the same programming language for easy operation. In one non-limiting embodiment, the programming language can be C.

The model-code 60 and the test-code 64 thus generated are integrated using a composer 66 and an integrated-code is obtained. The integrated code is passed onto an execution module 68 for executing the integrated-code. In the module 68, the testing tool correlates actual output values obtained from this execution with the expected output values corresponding to the model specifications. The testing tool in the present illustration is SPIN, as mentioned earlier. In one embodiment, the correlation happens in the form of a comparison, where the actual output values and the expected output values are compared. If there is a match for all possible inputs, the model is said to be valid. If the actual and expected output values do not match any of the input values, the model is said to be invalid. In this case, the testing tool generates a counter-example. This counter-example is used in tracing an error in the model as described in accordance with FIG. 2.

The system for validating a model for a control system as per a set of specifications of the control system, the specifications comprising input conditions and corresponding expected output values of one or more model-parameters, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive, optical-disk drive, etc. The storage device may also be other similar means for loading computer programs or other instructions into the computer system. The computer system also includes a communication unit. The communication unit allows the computer to connect to other databases and the Internet through an Input/Output (I/O) interface, allowing the transfer as well as reception of data from other databases. The communication unit may include a modem, an Ethernet card, or any other similar device, which enables the computer system to connect to databases and networks, such as LAN, MAN, WAN and the Internet. The computer system facilitates inputs from a user through input device, accessible to the system through an I/O interface.

The computer system executes a set of instructions that are stored in one or more storage elements in order to process input data. The storage elements may also hold data or other information as desired. The storage element may be in the form of an information source or a physical memory element present in the processing machine.

The programmable instructions may include various commands that instruct the processing machine to perform specific tasks, such as the steps that constitute the method of the present invention. The method and systems described can also be implemented using only software programming or using only hardware or by a varying combination of the two techniques. The present invention is independent of the programming language used and the operating system in the computers. The instructions for the invention can be written in all programming languages including, but not limited to, ‘C’, ‘C++’, ‘Visual C++’ and ‘Visual Basic’. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine. The invention can also be implemented in all operating systems and platforms including, but not limited to, ‘Unix’, ‘DOS’, and ‘Linux’.

The programmable instructions can be stored and transmitted on computer readable medium. The programmable instructions can also be transmitted by data signals across a carrier wave. The present invention can also be embodied in a computer program product comprising a computer readable medium, the product capable of implementing the above methods and systems, or the numerous possible variations thereof.

Various embodiments of the present invention offer one or more advantages. The present invention ensures that there is no need to build a formal model and carry out the subsequent verifications. The state values in the present invention are also closer to those in the actual model. Further, the verification in the present invention is done directly on the code, which is an artifact closer to the deployment stage. In addition, the present invention uses the existing powerful techniques built into the SPIN model checker instead of building a model checker from scratch.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for validating a model of a control system as per a set of specifications of the control system, the specifications including input conditions and corresponding expected output values of one or more model-parameters, the method comprising:
obtaining a model-code corresponding to the model, where the model-code is obtained using a modeling tool;
using a testing tool to generate a test-code capable of monitoring one or more model-parameters to be validated;
integrating the model-code and the test-code to obtain an integrated-code;
executing the integrated-code in the testing tool, wherein the testing tool correlates actual output values of the one or more model-parameters with the expected output values of the one or more model-parameters; and
identifying the model of the control system as one of valid or invalid based on the correlation between the actual output values of the one or more model-parameters with the expected output values of the one or more model-parameters.

2. The method according to claim 1 further comprising using the testing tool to check for temporal relationships between the input conditions and the output values.

3. The method according to claim 2 wherein the input conditions and the output values are specified in linear temporal logic.

4. The method according to claim 1 wherein the model of the control system is a Simulink/Stateflow (SL/SF) model.

5. The method according to claim 1 wherein the modeling tool is a real-time workshop (RTW) code generator.

6. The method according to claim 1 wherein the model-code and the test-code are integrated using a composer.

7. The method according to claim 1 further comprising generating a counter-example by the testing tool when the model is identified as invalid.

8. The method according to claim 6 wherein the counter-example is used to trace an error in the model.

9. A system for validating a model of a control system as per a set of specifications of the control system, the specifications including input conditions and corresponding expected output values of one or more model-parameters, the system comprising:
a first module for obtaining a model-code corresponding to the model, wherein the model-code is obtained from a modeling tool;
a second module using a testing tool to obtaining a test-code capable of monitoring one or more model-parameters to be validated;
a composer for integrating the model-code and the test-code to obtain an integrated-code; and
an execution module for executing the integrated-code in the testing tool, wherein the testing tool correlates actual output values of the one or more model-parameters with the expected output values of the one or more model-parameters, wherein the model of the control system is identified as one of valid or invalid based on the correlation between the actual output values of the one or more model-parameters with the expected output values of the one or more model-parameters.

10. The system according to claim 9 wherein the second module uses the testing tool to check for temporal relationships between the input conditions and the output values.

11. The system according to claim 10 wherein the input conditions and the output values are specified in linear temporal logic.

12. The system according to claim 9 wherein the model of the control system is a Simulink/Stateflow (SL/SF) model.

13. The system according to claim 9 wherein the modeling tool is a real-time workshop (RTW) code generator.

14. The system according to claim 9 wherein the testing tool generates a counter-example when the model is identified as invalid.

15. The system according to claim 14 wherein the counter-example is used to trace an error in the model.

16. A computer program product for validating a model of a control system as per a set of specifications of the control system, the specifications including input conditions and corresponding expected output values of one or more model-parameters, the computer program product comprising a computer readable medium comprising:
means for obtaining a model-code corresponding to the model, wherein the model-code is obtained using a modeling tool;
means for using a testing tool to generate a test-code capable of monitoring one or more model-parameters to be validated;
means for integrating the model-code and the test-code to obtain an integrated-code;
means for executing the integrated-code in the testing tool, wherein the testing tool correlates actual output values of the one or more model-parameters with the expected output values of the one or more model-parameters;
means for using the testing tool to check for temporal relationships between the input conditions and the output values, wherein the input conditions and the output values are specified in linear temporal logic; and
means for identifying the model of the control system as one of valid or invalid based on the correlation between the actual output values of the one or more model-parameters with the expected output values of the one or more model-parameters.

17. The product according to claim 16 wherein the model of the control system is a Simulink/Stateflow (SL/SF) model.

18. The product according to claim 16 wherein the modeling tool is a real-time workshop (RTW) code generator.

19. The product according to claim 16 wherein the testing tool generates a counter-example when the model is identified as invalid.

20. The product according to claim 19 wherein the counter-example is used to trace an error in the model.
